(19) United States
(12) Patent Application Publication
(10) Pub. No.: US 2022/0148119 A1
(43) Pub. Date: May 12, 2022

(54) COMPUTER-READABLE RECORDING MEDIUM STORING OPERATION CONTROL PROGRAM, OPERATION CONTROL METHOD, AND OPERATION CONTROL APPARATUS

(71) Applicant: FUJITSU LIMITED, Kawasaki-shi (JP)

(72) Inventors: Yasuto Yokota, Kawasaki (JP); Kanata Suzuki, Kawasaki (JP)

(73) Assignee: FUJITSU LIMITED, Kawasaki-shi (JP)

(21) Appl. No.: 17/463,367

(22) Filed: Aug. 31, 2021

(30) Foreign Application Priority Data
Nov. 11, 2020 (JP) 2020-187981

(51) Int. Cl. G06T 1/00; G06T 7/174; G06K 9/00; G06T 7/70

(52) U.S. Cl. CPC G06T 1/0014; G06T 7/174; G06T 2207/20016; G06T 7/70; G06T 2207/20081; G06K 9/00671

(57) ABSTRACT

A computer-readable recording medium stores an operation control program for causing a computer to execute processing including: specifying a region of an object in a first image obtained by capturing an operating environment of a device at a first timing; generating, by using a first machine learning model, second operation information that represents an operating state of the device at a second timing after the first timing on the basis of first operation information that represents an operating state of the device at the first timing; specifying, by using a second machine learning model, a region of the device in a second image that represents the operating environment of the device on the basis of the second operation information; comparing the region of the device with the region of the object; and executing an avoidance operation of the device on the basis of a result of the processing of comparing.

### CROSS-REFERENCE TO RELATED APPLICATION

This application is based upon and claims the benefit of priority of the prior Japanese Patent Application No. 2020-187981, filed on Nov. 11, 2020, the entire contents of which are incorporated herein by reference.

### FIELD

The embodiment discussed herein is related to an operation control technology.

### BACKGROUND

In recent years, to reduce teaching work of teaching operations to industrial robot arms, research is advancing on automating the teaching work by applying a machine learning technology such as deep reinforcement learning and recurrent neural networks to attitude control of robot arms. In the deep reinforcement learning, training needs a large cost (many trials) and a long time. Thus, in a case where there are restrictions on a cost and a training time, methods using the recurrent neural networks such as a recurrent neural network (RNN) and a long short-term memory (LSTM) are used.

Japanese Patent No. 6647640 and U.S. Patent Application Publication No. 2019/0143517 are disclosed as related art.

### SUMMARY

According to an aspect of the embodiments, a non-transitory computer-readable recording medium stores an operation control program for causing a computer to execute processing including: specifying a region of an object in a first image obtained by capturing an operating environment of a device at a first timing; generating, by using a first machine learning model, second operation information that represents an operating state of the device at a second timing after the first timing on the basis of first operation information that represents an operating state of the device at the first timing; specifying, by using a second machine learning model, a region of the device in a second image that represents the operating environment of the device on the basis of the second operation information; comparing the region of the device with the region of the object; and executing an avoidance operation of the device on the basis of a result of the processing of comparing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of an operation control system;

FIG. 2 is a diagram illustrating an example of a six-axis robot arm;

FIG. 3 is a diagram illustrating an exemplary configuration of an operation control apparatus;

FIG. 4 is a diagram illustrating an example of specification of a region of an object;

FIG. 5 is a diagram illustrating an example of specification of a region of the robot arm;

FIG. 6 is a diagram illustrating an example of generation of a neural network (NN) for the specification of the region of the robot arm;

FIG. 7 is a diagram illustrating an example of collision determination for each time;

FIG. 8 is a flowchart illustrating a flow of operation control processing; and

FIG. 9 is a diagram for explaining an exemplary hardware configuration.

### DESCRIPTION OF EMBODIMENTS

On the other hand, development of a robot arm assuming collaboration with humans is advancing, and a technology that prevents collision between the robot arm and another object is needed. Thus, there is a technology that detects an obstacle by using a camera image or a sensor, specifies three-dimensional position coordinates (x, y, z), and prevents collision between a robot arm and the obstacle.

However, since an attitude of the robot arm is not uniquely determined by the three-dimensional position coordinates (x, y, z), it is not possible to determine whether a position of the obstacle overlaps a track of the robot arm. Thus, when the obstacle is detected, an operation of the robot arm needs to be uniformly stopped in an emergency, which causes a problem that a work load and time for unnecessary restarting are needed.

In one aspect, an operation control program, an operation control method, and an operation control apparatus that are capable of previously preventing approach or collision between a robot arm and an obstacle may be provided.

Hereinafter, embodiments of an operation control program, an operation control method, and an operation control apparatus according to the present embodiment will be described in detail with reference to the drawings. Note that the embodiments do not limited the present embodiment. Furthermore, each of the embodiments may be appropriately combined within a range without inconsistency.

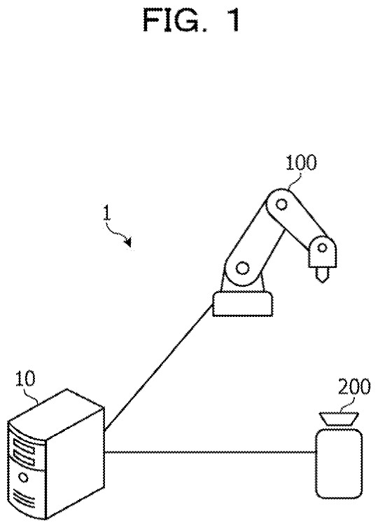

First, an operation control system for implementing the present embodiment will be described. FIG. 1 is a diagram illustrating an exemplary configuration of the operation control system. As illustrated in FIG. 1, an operation control system 1 is a system in which an operation control apparatus 10, a robot arm 100, and a camera device 200 are communicatively connected to each other. Note that communication of each device may be performed via a communication cable or may be performed via various communication networks such as an intranet. Furthermore, a communication method may be either wired method or wireless method.

The operation control apparatus 10 is, for example, an information processing apparatus such as a desktop personal computer (PC), a notebook PC, or a server computer used by an administrator who manages the robot arm 100. The operation control apparatus 10 specifies an object from a captured image of an operating environment of the robot arm 100, predicts a track of the robot arm 100, and in a case where there is a possibility that the robot arm 100 collides with the object, executes an avoidance operation of the robot arm 100. Note that the object specified from the captured image of the operating environment of the robot arm 100 may be referred to as an obstacle regardless of whether or not there is a possibility of actually colliding with the robot arm 100.

Furthermore, although the operation control apparatus 10 is illustrated as one computer in FIG. 1, the operation control apparatus 10 may be a distributed computing system including a plurality of computers. Furthermore, the operation control apparatus 10 may be a cloud server device managed by a service provider that provides a cloud computing service.

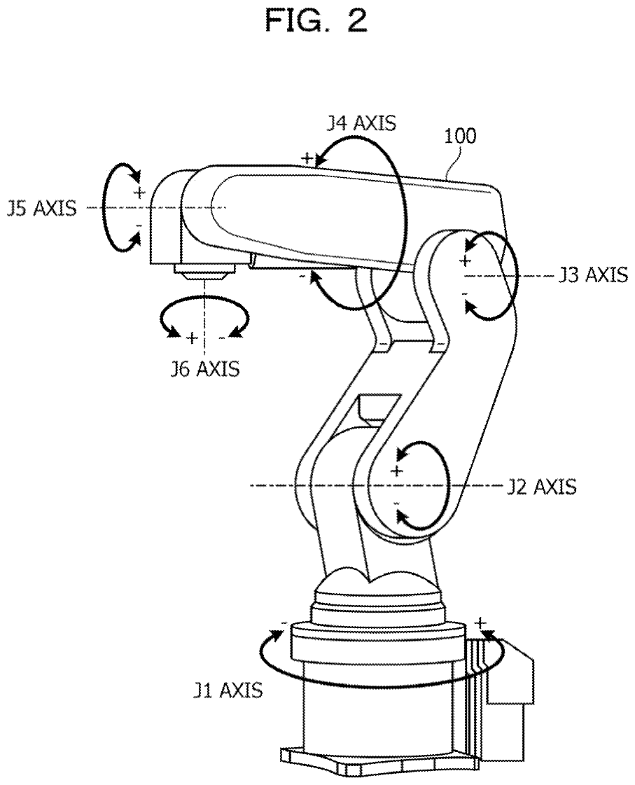

The robot arm 100 is, for example, a robot arm for industrial use, and is, more specifically, a picking robot that picks up (grips) and moves an article in a factory, a warehouse, or the like. However, the robot arm is not limited to the robot arm for industrial use, and may be a robot arm for medical use or the like. FIG. 2 is a diagram illustrating an example of a six-axis robot arm. In the example of FIG. 2, the robot arm 100 has six joints J1 to J6, and rotates around J1 to J6 axes of the joints. The robot arm 100 receives input of change for each time in attitude information of each joint, for example, in an angle of the axis of each joint from the operation control apparatus 10, so that a track of the robot arm 100 is determined and the robot arm 100 is controlled to perform a predetermined operation. Note that the number of axes of the robot arm 100 is not limited to six axes, and may be less or more than six axes, such as five axes or seven axes.

The camera device 200 captures, from a side of or above the robot arm 100, an image of an operating environment of the robot arm 100, for example, a range in which the robot arm 100 may operate. The camera device 200 captures the image of the operating environment in real time while the robot arm 100 is operating, and the captured image is transmitted to the operation control apparatus 10. Note that, although only one camera device 200 is illustrated in FIG. 1, images of the operating environment may be captured from a plurality of directions such as the side of and above the robot arm 100 by a plurality of the camera devices 200.

### Functional Configuration of Operation Control Apparatus 10

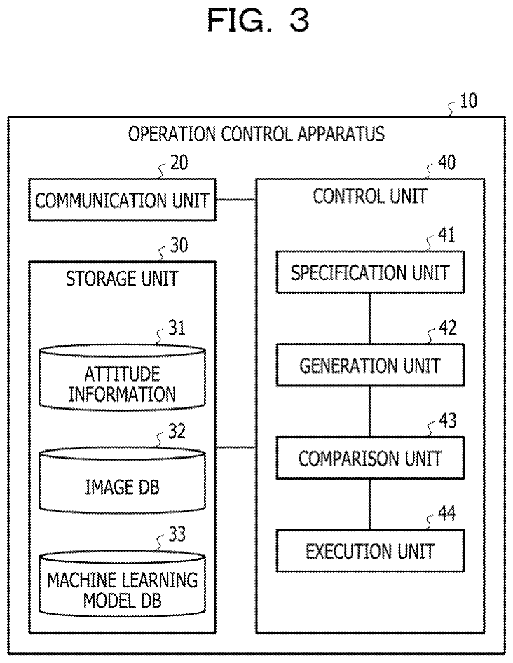

Next, a functional configuration of the operation control apparatus 10 illustrated in FIG. 1 will be described. FIG. 3 is a diagram illustrating an exemplary configuration of the operation control apparatus. As illustrated in FIG. 3, the operation control apparatus 10 includes a communication unit 20, a storage unit 30, and a control unit 40.

The communication unit 20 is a processing unit that controls communication with another device such as the robot arm 100 or the camera device 200, and is, for example, a communication interface such as a universal serial bus (USB) interface or a network interface card.

The storage unit 30 is an example of a storage device that stores various types of data and a program executed by the control unit 40, and is, for example, a memory, a hard disk, or the like. The storage unit 30 stores attitude information 31, an image database (DB) 32, a machine learning model DB 33, and the like.

The attitude information 31 is information for controlling an operation of the robot arm 100, and stores, for example, information indicating an angle of the axis of each joint of the robot arm 100. For example, in the case of the six-axis robot arm illustrated in FIG. 2, the attitude information 31 indicates angles of the J1 to J6 axes of the joints by m1 to m6.

The image DB 32 stores a captured image of an operating environment of the robot arm 100 captured by the camera device 200. Furthermore, the image DB 32 stores a mask image indicating a region of an obstacle, which is output by inputting the captured image to an object detector. Furthermore, the image DB 32 stores a mask image indicating a region of the robot arm 100, which is output by inputting the attitude information 31 to a neural network (NN).

The machine learning model DB 33 stores, for example, model parameters for constructing an object detector generated by machine learning using a captured image of an operating environment of the robot arm 100 as a feature amount and a mask image indicating a region of an obstacle as a correct label, and training data for the object detector.

Furthermore, the machine learning model DB 33 stores, for example, model parameters for constructing a NN generated by machine learning using the attitude information 31 as a feature amount and a mask image indicating a region of the robot arm 100 as a correct label, and training data for the NN.

Furthermore, the machine learning model DB 33 stores, for example, model parameters for constructing a recurrent NN (RNN) generated by machine learning using current attitude information 31 as a feature amount and future attitude information 31 as a correct label, and training data for the RNN.

Note that the information described above stored in the storage unit 30 is merely an example, and the storage unit 30 may store various types of information other than the information described above.

The control unit 40 is a processing unit that controls the entire operation control apparatus 10 and is, for example, a processor. The control unit 40 includes a specification unit 41, a generation unit 42, a comparison unit 43, and an execution unit 44. Note that each processing unit is an example of an electronic circuit included in a processor or an example of a process executed by the processor.

The specification unit 41 specifies a region of an object in an image obtained by capturing an operating environment of a device such as the robot arm 100 at a first timing. The first timing is, for example, the present. Note that a plurality of the camera devices 200 may capture images of the operating environment from a plurality of directions such as a side of and above the device. In this case, the specification unit 41 specifies the region of the object in each of the images captured from each direction.

Furthermore, on the basis of operation information representing an operating state of the device at a second timing after the first timing, the specification unit 41 specifies, by using a machine learning model, a region of the device in an image representing an operating environment of the device at the second timing. The machine learning model is, for example, a NN generated by machine learning using the attitude information 31, which is the operation information representing the operating state of the device such as the robot arm 100, as a feature amount and a mask image indicating the region of the device as a correct label.

Note that the mask image output by the machine learning model may be a plurality of images representing the operating environment of the device from a plurality of directions such as a side of and above the device. In this case, the specification unit 41 specifies the region of the device for each mask image.

Furthermore, a resolution of the mask image output by the machine learning model may be lower than a resolution of the image captured by the camera device 200. Furthermore, in the mask image, for example, pixels of the device may be represented in black and other pixels may be represented in white, so that binarization is performed. With this configuration, a processing load of the operation control apparatus 10 on the mask image may be reduced.

The generation unit 42 generates, by using a machine learning model, second operation information representing an operating state of the device at the second timing after the first timing, on the basis of, for example, first operation information representing an operating state of the device at the first timing that is the present. More specifically, the generation unit 42 generates the future attitude information 31 of the robot arm 100 by using the machine learning model on the basis of, for example, the current attitude information 31 of the robot arm 100. The machine learning model is, for example, an RNN generated by machine learning using the attitude information 31 of the robot arm 100 at a predetermined time t as a feature amount and the attitude information 31 at a time t+1 after the time t as a correct label. By inputting the attitude information 31 at the current time t to the RNN, the attitude information 31 at the future time t+1 is output. Moreover, the generation unit 42 may further generate the attitude information 31 at a future time t+2 by inputting the attitude information 31 at the future time t+1 to the RNN, and by repeating this, the generation unit 42 may generate the attitude information 31 at future times t+3, t+t+n (n is an optional integer).

In this way, the generation unit 42 predicts the future attitude information 31 on the basis of the current attitude information 31 of the device. However, in a case where the attitude information 31 that controls a series of operations of the device is created in advance, the operation control apparatus 10 may acquire the future attitude information 31 from the attitude information 31 created in advance. In this case, the operation control apparatus 10 does not need to include the generation unit 42.

The comparison unit 43 compares a region of a device such as the robot arm 100 with a region of an object, which are specified by the specification unit 41. In the comparison, for example, a composite image is generated by matching resolutions of a mask image in which the region of the device is specified and a captured image in which the region of the object is specified, and whether or not there is overlap on the image between the region of the device and the region of the object, for example, whether or not there is collision between the device and the object, is determined. Alternatively, in the comparison, the shortest distance on the composite image between the region of the device and the region of the object is measured, for example, approach and collision between the device and the object are determined. The reason for measuring the distance in this way is to detect approach within a predetermined distance between the device and the object since there is a possibility of collision in a case where the device and the object are close to each other even when the both regions do not overlap.

The execution unit 44 executes an avoidance operation of a device on the basis of a result of comparison processing between a region of the device and a region of an object by the comparison unit 43. More specifically, the execution unit 44 executes the avoidance operation of the device in a case where, for example, the comparison unit 43 determines that the region of the device and the region of the object overlap on an image. Alternatively, the execution unit 44 executes the avoidance operation of the device in a case where, for example, the shortest distance on the image between the region of the device and the region of the object, which is measured by the comparison unit 43, is equal to or lower than a predetermined threshold. Note that, although the threshold may be optionally set to, for example, 5 pixels corresponding to about 10 centimeters in an actual distance, the threshold may be set larger or smaller depending on whether or not there is a possibility of movement of the object or granularity of a resolution of the composite image. Furthermore, examples of the avoidance operation of the device include, not only an emergency stop of the device but also an avoidance operation of the object by correction of a track of the device.

### Details of Functions

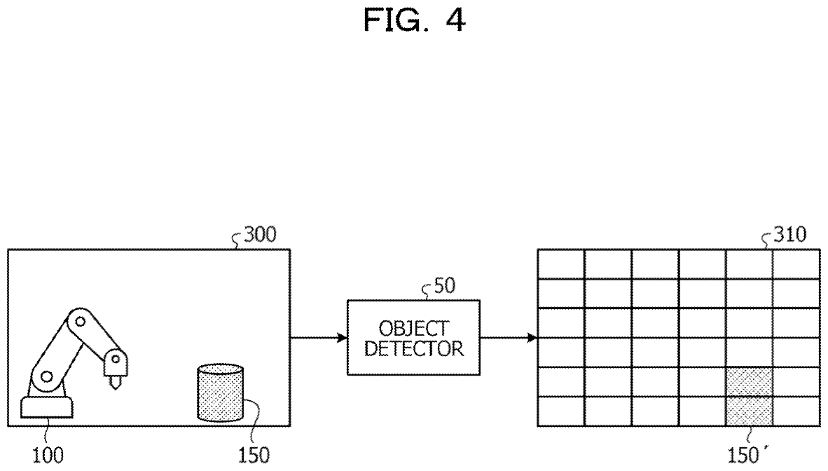

Next, each function will be described in detail with reference to FIGS. 4 to 7. First, specification of a region of an object in an image obtained by capturing an operating environment of a device such as the robot arm 100 by the specification unit 41 will be described. FIG. 4 is a diagram illustrating an example of the specification of the region of the object. A captured image 300 is an image obtained by capturing an operating environment of the robot arm 100 by the camera device 200 from a side of the robot arm 100. In addition to the robot arm 100, the captured image 300 includes an object 150 that may be an obstacle.

An object detector 50 illustrated in FIG. 4 is generated by machine learning using the captured image of the operating environment of the robot arm 100 as a feature amount and a mask image indicating a region of the object as a correct label. The object detector 50 detects an object from an image by using, for example, a single shot multibox detector (SSD) of object detection algorithm.

In FIG. 4, a mask image 310 output by inputting the captured image 300 to the object detector 50 is acquired. The mask image 310 is, for example, binarized representation of pixels 150′ of the object 150 and other pixels, whereby the specification unit 41 may specify the object 150. Furthermore, as illustrated in FIG. 4, by lowering a resolution of the mask image 310 to be lower than a resolution of the captured image 300, a processing load of the operation control apparatus 10 on the mask image 310 may be reduced.

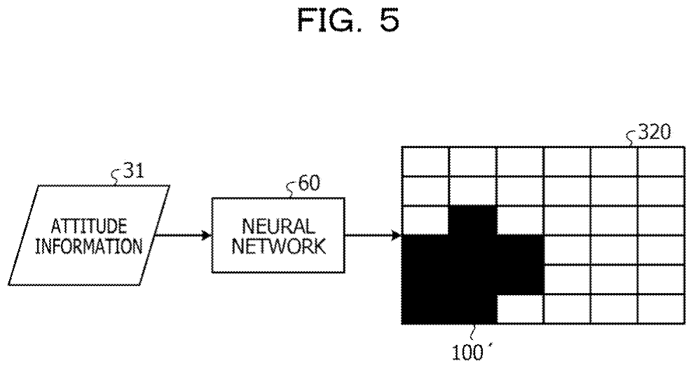

Next, specification of a region of a device such as the robot arm 100 by the specification unit 41 will be described. FIG. 5 is a diagram illustrating an example of the specification of the region of the robot arm. A NN 60 illustrated in FIG. 5 is generated by machine learning using the attitude information 31 of the robot arm 100 as a feature amount and a mask image indicating the region of the robot arm 100 as a correct label. For the NN 60, for example, a recurrent NN such as an RNN or a long short-term memory (LSTM) may be used.

In FIG. 5, the attitude information 31 of the robot arm 100 is input to the NN 60 to acquire a mask image 320. The mask image 320 is, for example, binarized representation of pixels 100′ of the robot arm 100 and other pixels, whereby the specification unit 41 may specify the robot arm 100. Furthermore, similarly to the mask image 310, by lowering a resolution of the mask image 320, a processing load of the operation control apparatus 10 on the mask image 320 may be reduced.

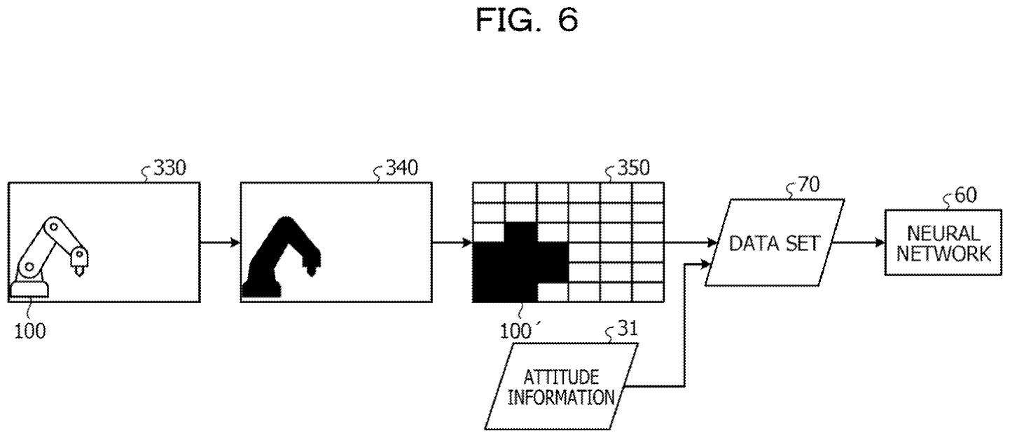

Here, a method of generating the NN 60 used for the specification of the region of the robot arm 100 will be described. FIG. 6 is a diagram illustrating an example of generation of the NN for the specification of the region of the robot arm. First, as illustrated in FIG. 6, a mask image 340 is generated by extracting, on the basis of a difference from a background image, pixels of the robot arm 100 from a captured image 330 obtained by capturing the robot arm 100 from a side by the camera device 200. Then, a resolution of the mask image 340 is lowered to generate a mask image 350 which is a binarized representation of pixels 100′ of the robot arm 100 and other pixels.

Then, a correct data set 70 is generated, in which the attitude information 31 when the captured image 330 is captured is input and the mask image 350 is output, and the NN 60 is trained by using the data set 70. By using a plurality of pieces of the attitude information 31 for controlling various attitudes that the robot arm 100 may take, the attitude of the robot arm 100 is changed to generate a plurality of the mask images 350 and data sets 70, and the NN 60 is trained.

Note that, in the example of FIG. 6, the generation of the NN 60 that specifies the region of the robot arm 100 in a case where the robot arm 100 is viewed from the side has been described by using the image of the robot arm 100 captured from the side. Similarly, for example, it is possible to generate an NN 60 that specifies a region of the robot arm 100 in a case where the robot arm 100 is viewed from above from the attitude information 31 of the robot arm 100 by using an image of the robot arm 100 captured from above.

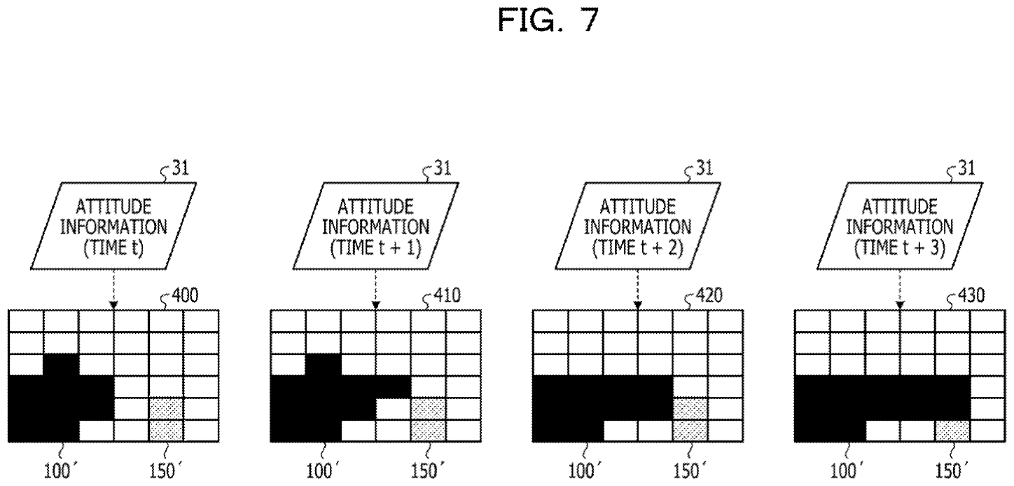

Next, collision determination by the comparison unit 43 will be described. FIG. 7 is a diagram illustrating an example of the collision determination for each time. Composite images 400 to 430 illustrated in FIG. 7 are images obtained by superimposing the mask image 310 which is output by the object detector 50 and in which the pixels 150′ of the object 150 are specified and the mask image 320 which is output by the NN 60 and in which the pixels 100′ of the robot arm 100 are specified. Between the composite images 400 to 430, time in an operating environment of the robot arm 100 is different. In the example of FIG. 7, the time in the operating environment elapses in the order of the composite images 400 to 430 from a time t to a time t+3.

Furthermore, in the example of FIG. 7, the composite images 400 to 430 indicate a state where the robot arm 100 is controlled first by using the attitude information 31 at the time t, and the robot arm 100 gradually approaches the object 150 as time elapses. For example, in the composite image 430, the pixels 100′ of the robot arm 100 and the pixels 150′ of the object 150 overlap, which indicates that the robot arm 100 and the object 150 collide with each other by controlling the robot arm 100 by using the attitude information 31 at the time t+3.

In this way, the attitude information 31 for each time is used to generate a composite image of an image of a device such as the robot arm 100 and an image of an object, and on the basis of overlap of pixels or a distance between the pixels on the composite image, whether there is the object in a track of the device is determined, so that it is possible to previously avoid approach or collision between the device and the object. Note that the attitude information 31 for each time is generated or acquired by the operation control apparatus 10 as described above.

### Flow of Processing

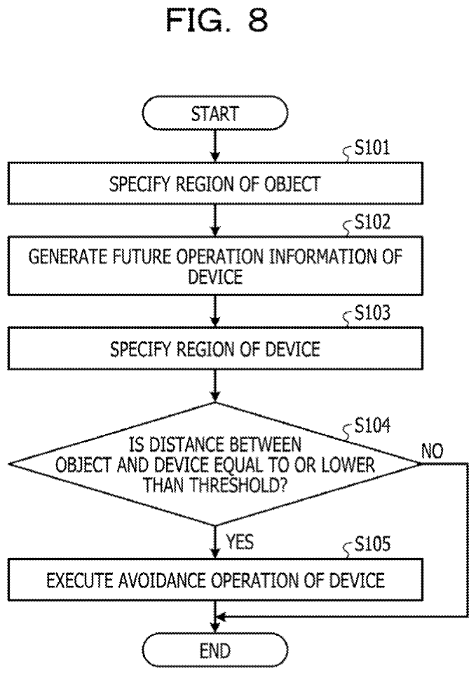

Next, a flow of operation control processing of a device such as the robot arm 100, which is executed by the operation control apparatus 10, will be described. FIG. 8 is a flowchart illustrating the flow of the operation control processing. The operation control processing illustrated in FIG. 8 is mainly executed by the operation control apparatus 10, and is executed in real time while the device is operating in order to previously avoid approach or collision between the device and the object 150. Thus, images of an operating environment of the operating device are captured by the camera device 200 at all times, and the captured images are transmitted to the operation control apparatus 10.

First, as illustrated in FIG. 8, the operation control apparatus 10 uses the object detector 50 to specify a region of the object 150 in a captured image in which the operating environment of the operating device is captured (Step S101). The captured image is the latest captured image transmitted from the camera device 200, for example, a captured image at a current time t. Furthermore, in a case where there is a plurality of captured images captured from a plurality of directions such as a side of and above the device, the operation control apparatus 10 specifies the region of the object 150 in each image.

Next, on the basis of the attitude information 31 of the device at the current time t, the operation control apparatus 10 uses a machine learning model to generate operation information at a future time t+1, for example, future attitude information 31, of the device (Step S104). Here, the future time t+1 is, for example, several seconds after the current time t. Furthermore, the machine learning model used in Step S102 is, for example, an RNN generated by machine learning using the attitude information 31 at the current time t as a feature amount and the attitude information 31 at the future time t+1 as a correct label. By inputting the attitude information 31 of the device at the current time t to the RNN, the attitude information 31 at the future time t+1 is output.

Note that, in a case where the attitude information 31 that controls a series of operations of the device is created in advance, the operation control apparatus 10 may also acquire the future attitude information 31 from the attitude information 31 created in advance. In this case, in Step S102, instead of generating the future attitude information 31, the operation control apparatus 10 acquires the future attitude information 31 from the attitude information 31 stored in advance in the storage unit 30.

Furthermore, the operation control apparatus 10 may further generate the attitude information 31 at a future time t+2 by inputting the generated attitude information 31 at the future time t+1 to the RN N, and by repeating this a predetermined number of times, the operation control apparatus 10 may generate the attitude information 31 at future times t+3 to t+n for each elapse of time.

Next, the operation control apparatus 10 specifies a future region of the device from the mask image 320 output by inputting the future attitude information 31 generated or acquired in Step S102 to the NN 60 (Step S103). In a case where there is a plurality of pieces of the future attitude information 31 at the future times t+1 to t+n, the operation control apparatus 10 specifies the region of the device at each time. Moreover, in a case where there is a plurality of the captured images used in Step S101, which is captured from a plurality of directions such as the side of and above the device, the operation control apparatus 10 specifies the future region of the device from each of a plurality of the mask images 320 viewed from each direction.

Next, the operation control apparatus 10 compares the region of the object 150 specified in Step S101 with the future region of the device specified in Step S103, and determines whether or not a distance between the object 150 and the device is equal to or lower than a predetermined threshold (Step S104). In a case where the distance is larger than the predetermined threshold (Step S104: No), it is determined that there is no possibility of approach or collision between the object 150 and the device, and the operation control processing illustrated in FIG. 8 ends. Note that, thereafter, the operation control processing is repeatedly executed from Step S101 according to elapse of time such that the future time t+1 becomes the current time, for example, and while the device is operating, the determination of approach or collision between the object 150 and the device is repeatedly performed.

On the other hand, in a case where the distance is equal to or lower than the predetermined threshold (Step S104: Yes), the operation control apparatus 10 determines that there is a possibility of approach or collision between the object 150 and the device, and executes an avoidance operation of the device (Step S105). Note that, examples of the avoidance operation of the device include an emergency stop of the device and an avoidance operation of the object by correction of a track of the device. After the execution of Step S105, the operation control processing illustrated in FIG. 8 ends.

Note that, in a case where there is a plurality of the captured images used in Step S101 and a plurality of the mask images 320 used in Step S103 for each direction of the device, it is determined in Step S104 whether or not the distance between the object 150 and the device is equal to or lower than the predetermined threshold on the image for each direction. As a result, in a case where the distance between the object 150 and the device is equal to or lower than the predetermined threshold on all images for each direction, the operation control apparatus 10 determines that there is a possibility of approach or collision between the object 150 and the device, and executes the avoidance operation of the device (Step S105). This is because it may be determined that there is no possibility of approach or collision between the object 150 and the device even when the distance between the object 150 and the device is equal to or lower than the predetermined threshold only on a part of the images.

Furthermore, in the determination in Step S104, whether or not there is overlap on the image between the region of the object 150 and the future region of the device may be determined. In a case where there is the overlap, the operation control apparatus 10 determines that there is a possibility of approach or collision between the object 150 and the device, and executes the avoidance operation of the device (Step S105).

### Effects

As described above, the operation control apparatus 10 specifies a region of an object in a first image obtained by capturing an operating environment of a device at a first timing, generates, by using a first machine learning model, second operation information that represents an operating state of the device at a second timing after the first timing on the basis of first operation information that represents an operating state of the device at the first timing, specifies, by using a second machine learning model, a region of the device in a second image that represents the operating environment of the device on the basis of the second operation information, compares the region of the device with the region of the object, and executes an avoidance operation of the device on the basis of a result of the processing of comparing.

The operation control apparatus 10 specifies the region of the object 150 from the captured image 300 of the operating environment of the device such as the robot arm 100, specifies the future region of the device by using machine learning from the attitude information 31 of the device, and executes the avoidance operation of the device on the basis of the comparison result of both regions. With this configuration, the operation control apparatus 10 may previously prevent approach or collision between the device and the object 150.

Furthermore, the processing of specifying the region of the device, which is executed by the operation control apparatus 10, includes processing of specifying the region of the device from the second image that has a resolution lower than a resolution of the first image and is output by inputting the second operation information to the second machine learning model.

With this configuration, a processing load of the operation control apparatus 10 on the mask image 320, which is the second image, may be reduced.

Furthermore, the processing of specifying the region of the device, which is executed by the operation control apparatus 10, includes processing of specifying the region of the device from the second image in which pixels that indicate the device and pixels that indicate other than the device are binarized and which is output by inputting the second operation information to the second machine learning model.

With this configuration, a processing load of the operation control apparatus 10 on the mask image 320, which is the second image, may be reduced.

Furthermore, the processing of comparing the region of the device with the region of the object, which is executed by the operation control apparatus 10, includes processing of matching the resolutions of the first image and the second image and determining whether or not there is overlap on an image between the region of the device and the region of the object, and the processing of executing the avoidance operation of the device, which is executed by the operation control apparatus 10, includes processing of executing the avoidance operation of the device in a case where it is determined that there is the overlap.

With this configuration, the operation control apparatus 10 may more accurately determine approach or collision between the device and the object 150.

Furthermore, the processing of comparing the region of the device with the region of the object, which is executed by the operation control apparatus 10, includes processing of matching the resolutions of the first image and the second image and measuring a shortest distance on the image between the region of the device and the region of the object, and the processing of executing the avoidance operation of the device, which is executed by the operation control apparatus 10, includes processing of executing the avoidance operation of the device in a case where the shortest distance is equal to or lower than a predetermined threshold.

With this configuration, the operation control apparatus 10 may more accurately determine approach or collision between the device and the object 150.

Furthermore, the processing of specifying the region of the object, which is executed by the operation control apparatus 10, includes processing of specifying the region of the object in a plurality of the first images obtained by capturing the operating environment of the device from a plurality of different directions, and the processing of specifying the region of the device, which is executed by the operation control apparatus 10, includes processing of specifying the region of the device in a plurality of the second images that represents the operating environment of the device from a plurality of different directions.

With this configuration, the operation control apparatus 10 may determine approach or collision between the device and the object 150 from a plurality of directions.

### System

Pieces of information including a processing procedure, a control procedure, a specific name, various types of data, and parameters described above or illustrated in the drawings may be optionally changed unless otherwise specified. Furthermore, the specific examples, distributions, numerical values, and the like described in the embodiments are merely examples, and may be optionally changed.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part of the devices may be configured by being functionally or physically distributed or integrated in optional units according to various types of loads, usage situations, or the like. Moreover, all or an optional part of each processing function performed in each device may be implemented by a central processing unit (CPU) and a program analyzed and executed by the CPU, or may be implemented as hardware by wired logic.

### Hardware

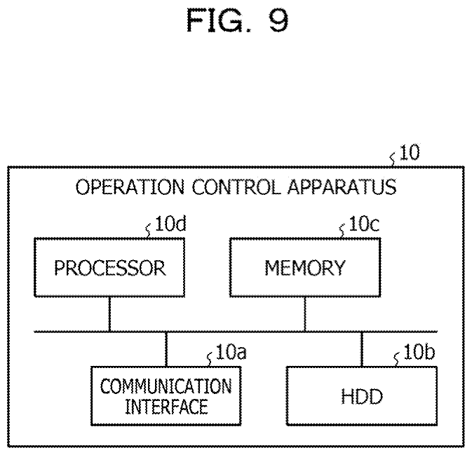

FIG. 9 is a diagram for explaining an exemplary hardware configuration. As illustrated in FIG. 9, the operation control apparatus 10 includes a communication interface 10a, a hard disk drive (HDD) 10b, a memory 10c, and a processor 10d. Furthermore, the units illustrated in FIG. 9 are mutually connected by a bus or the like.

The communication interface 10a is a network interface card or the like and communicates with another server. The HDD 10b stores a program for operating the functions illustrated in FIG. 3, and a DB.

Me processor 10d is a hardware circuit that reads a program that executes processing similar to the processing of each processing unit illustrated in FIG. 3 from the HDD 10b or the like, and develops the read program in the memory 10c, to operate a process that executes each function described with reference to FIG. 3 or the like. For example, this process executes a function similar to the function of each processing unit included in the operation control apparatus 10. For example, the processor 10d reads a program having functions similar to the functions of the specification unit 41, the generation unit 42, the comparison unit 43, the execution unit 44, and the like from the HDD 10b or the like. Then, the processor 10d executes a process that executes processing similar to the processing of the specification unit 41, the generation unit 42, the comparison unit 43, the execution unit 44, and the like.

In this way, the operation control apparatus 10 operates as an information processing apparatus that executes the operation control processing by reading and executing a program that executes processing similar to the processing of each processing unit illustrated in FIG. 3. Furthermore, the operation control apparatus 10 may also implement functions similar to the functions of the embodiments described above by reading a program from a recording medium by a medium reading device and executing the read program. Note that the program mentioned in other embodiments is not limited to being executed by the operation control apparatus 10. For example, the present embodiment may be similarly applied also to a case where another computer or server executes the program, or a case where these cooperatively execute the program.

Furthermore, the program that executes processing similar to the processing of each processing unit illustrated in FIG. 3 may be distributed via a network such as the Internet. Furthermore, the program may be recorded in a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an operation control program for causing a computer to execute processing comprising:
specifying a region of an object in a first image obtained by capturing an operating environment of a device at a first timing;
generating, by using a first machine learning model, second operation information that represents an operating state of the device at a second timing after the first timing on the basis of first operation information that represents an operating state of the device at the first timing;
specifying, by using a second machine learning model, a region of the device in a second image that represents the operating environment of the device on the basis of the second operation information;
comparing the region of the device with the region of the object; and
executing an avoidance operation of the device on the basis of a result of the processing of comparing.

2. The non-transitory computer-readable recording medium storing the operation control program according to claim 1, wherein the processing of specifying the region of the device includes processing of specifying the region of the device from the second image that has a resolution lower than a resolution of the first image and is output by inputting the second operation information to the second machine learning model.

3. The non-transitory computer-readable recording medium storing the operation control program according to claim 2, wherein the processing of specifying the region of the device includes processing of specifying the region of the device from the second image in which pixels that indicate the device and pixels that indicate other than the device are binarized and which is output by inputting the second operation information to the second machine learning model.

4. The non-transitory computer-readable recording medium storing the operation control program according to claim 1, wherein
the processing of comparing the region of the device with the region of the object includes processing of determining whether or not there is overlap between a position of the region of the device in the second image and a position of the region of the object in the first image, and
the processing of executing the avoidance operation of the device includes processing of executing the avoidance operation of the device in a case where it is determined that there is the overlap.

5. The non-transitory computer-readable recording medium storing the operation control program according to claim 1, wherein
the processing of comparing the region of the device with the region of the object includes processing of measuring a shortest distance between a position of the region of the device in the second image and a position of the region of the object in the first image, and
the processing of executing the avoidance operation of the device includes processing of executing the avoidance operation of the device in a case where the shortest distance is equal to or lower than a predetermined threshold.

6. The non-transitory computer-readable recording medium storing the operation control program according to claim 1, wherein
the processing of specifying the region of the object includes processing of specifying the region of the object in a plurality of the first images obtained by capturing the operating environment of the device from a plurality of different directions, and
the processing of specifying the region of the device includes processing of specifying the region of the device in a plurality of the second images that represents the operating environment of the device from a plurality of different directions.

7. An operation control method comprising:
specifying a region of an object in a first image obtained by capturing an operating environment of a device at a first timing;
generating, by using a first machine learning model, second operation information that represents an operating state of the device at a second timing after the first timing on the basis of first operation information that represents an operating state of the device at the first timing;
specifying, by using a second machine learning model, a region of the device in a second image that represents the operating environment of the device on the basis of the second operation information;
comparing the region of the device with the region of the object; and
executing an avoidance operation of the device on the basis of a result of the processing of comparing.

8. The operation control method according to claim 7, wherein the processing of specifying the region of the device includes processing of specifying the region of the device from the second image that has a resolution lower than a resolution of the first image and is output by inputting the second operation information to the second machine learning model.

9. The operation control method according to claim 8, wherein the processing of specifying the region of the device includes processing of specifying the region of the device from the second image in which pixels that indicate the device and pixels that indicate other than the device are binarized and which is output by inputting the second operation information to the second machine learning model.

10. The operation control method according to claim 7, wherein
the processing of comparing the region of the device with the region of the object includes processing of determining whether or not there is overlap between a position of the region of the device in the second image and a position of the region of the object in the first image, and
the processing of executing the avoidance operation of the device includes processing of executing the avoidance operation of the device in a case where it is determined that there is the overlap.

11. The operation control method according to claim 7, wherein
the processing of comparing the region of the device with the region of the object includes processing of measuring a shortest distance between a position of the region of the device in the second image and a position of the region of the object in the first image, and
the processing of executing the avoidance operation of the device includes processing of executing the avoidance operation of the device in a case where the shortest distance is equal to or lower than a predetermined threshold.

12. The operation control method according to claim 7, wherein
the processing of specifying the region of the object includes processing of specifying the region of the object in a plurality of the first images obtained by capturing the operating environment of the device from a plurality of different directions, and
the processing of specifying the region of the device includes processing of specifying the region of the device in a plurality of the second images that represents the operating environment of the device from a plurality of different directions.

13. An information processing apparatus comprising:
a memory; and
a processor coupled to the memory and configured to:
specify a region of an object in a first image obtained by capturing an operating environment of a device at a first timing;
generate, by using a first machine learning model, second operation information that represents an operating state of the device at a second timing after the first timing on the basis of first operation information that represents an operating state of the device at the first timing;
specify, by using a second machine learning model, a region of the device in a second image that represents the operating environment of the device on the basis of the second operation information;
compare the region of the device with the region of the object; and
execute an avoidance operation of the device on the basis of a result of the processing of comparing.

14. The information processing apparatus according to claim 13, wherein the processor specifies the region of the device from the second image that has a resolution lower than a resolution of the first image and is output by inputting the second operation information to the second machine learning model.

15. The information processing apparatus according to claim 14, wherein the processor specifies the region of the device from the second image in which pixels that indicate the device and pixels that indicate other than the device are binarized and which is output by inputting the second operation information to the second machine learning model.

16. The information processing apparatus according to claim 13, wherein the processor
determines whether or not there is overlap between a position of the region of the device in the second image and a position of the region of the object in the first image, and
executes the avoidance operation of the device in a case where it is determined that there is the overlap.

17. The information processing apparatus according to claim 1 wherein the processor
measures a shortest distance between a position of the region of the device in the second image and a position of the region of the object in the first image, and
executes the avoidance operation of the device includes processing of executing the avoidance operation of the device in a case where the shortest distance is equal to or lower than a predetermined threshold.

18. The information processing apparatus according to claim 13, wherein the processor
specifies the region of the object in a plurality of the first images obtained by capturing the operating environment of the device from a plurality of different directions, and
specifies the region of the device in a plurality of the second images that represents the operating environment of the device from a plurality of different directions.
